(19) United States
(12) Patent Application Publication
(10) Pub. No.: US 2012/0308686 A1
(43) Pub. Date: Dec. 6, 2012

(54) Nutritional Compositions for Bees

(76) Inventors: Gordon Wardell, Tucson, AZ (US); Fabiana Ahumada-Segura, Tucson, AZ (US)

(21) Appl. No.: 13/584,629

(22) Filed: Aug. 13, 2012

Related U.S. Application Data
(63) Continuation of application No. 11/962,328, filed on Dec. 21, 2007, now abandoned.

(51) Int. Cl. A23K 1/18; A23K 1/06; A23K 1/16

(52) U.S. Cl. 426/62; 426/656; 426/532

(57) ABSTRACT

A high-protein nutritional composition for bees including protein derived from at least two sources including corn gluten, lipid derived from at least two sources including corn gluten, and carbohydrate.

### CROSS REFERENCE TO RELATED APPLICATIONS

This application is a continuation application and claims the benefit of priority to U.S. application Ser. No. 11/962,328, entitled “Nutritional Compositions for Bees” filed on Dec. 21, 2007, the entire contents of which are incorporated by reference.

### FIELD OF THE INVENTION

The invention relates to compositions for consumption by bees.

### DESCRIPTION OF THE RELATED ART

Honey bees are necessary to pollinate important agricultural crops and also to produce honey and wax for commercial markets. In the United States, honey bees produce $270 million worth of honey, beeswax, and other hive products and pollinate over $14 billion worth of crops annually.

Honey bees typically need a complex mixture of proteins, carbohydrates, fats, minerals, and vitamins to maintain normal growth and development. Usually, honey bees are able to acquire all of their dietary needs from available flowers or stored resources in the hive. Under normal circumstances, bees are able to forage and store enough pollen and honey to provide for their nutritional needs throughout the year. However, movement of hives creates circumstances wherein normal foraging and/or stored resources are not adequate to provide bees with needed nutrition.

In the United States, over 2 million hives are moved annually to provide commercial crop pollination. Migratory beekeeping places unusual stresses on the bees to the point that their stored pollen and honey resources diminish, and the nutritional state of the colony ultimately shuts down brood rearing due to a lack of available protein and nutrients. In addition, when hives are moved to a new site, there may be inadequate natural food sources at the new location such that supplemental feed is required to maintain hive vigor.

Since the mid 1930s, work on artificial diets for honey bees as a replacement for pollen has been carried out. Currently known artificial diets for honey bees include liquid artificial nectars which comprise a carbohydrate or sugar source, pollen patties made of pollen and sugars, patties made of soy protein (usually solvent extracted) mixed with brewers yeast and sugar, patties made from a mixture of soy flour, Torula or brewers yeast, pollard, vegetable oil, vitamin mix and irradiated honey or malt, patties made from a mixture of expeller-pressed soy flour, pollard, cotton seed oil, vitamin mix and irradiated honey or malt, and Haydak diet patties made of soy meal, brewers yeast, sugar, and powered skim milk. A drawback of known artificial diets for honey bees is that they do not sustain brood rearing and thus are not suitable for the continuous rearing of bees.

The effects of stress and nutritional problems on bee populations can be devastating. Recently, the so-called “Colony Collapse Disorder” (CCD) has been widely publicized. CCD is a poorly understood phenomenon involving the massive die-off of bee hives or colonies. One of the patterns reported by researchers into the causes of CCD has been the presence of poor nutrition and/or drought prior to hive or colony collapse. To date, this is the only factor that all of the reported cases of CCD have in common. Thus, there is good reason to believe that CCD is at least correlated to nutritional stress.

### SUMMARY OF THE INVENTION

The invention relates in general to nutritional compositions and formulations that provide honey bees with a fully nutritious, easily digestible, complex mixture of nutrients in amounts and proportions effective to support growth and development of honey bees, sustain brood rearing, and maintain hive vigor. More specifically, the invention relates to nutritional compositions and formulations that utilize corn gluten and at least one other source of protein and lipid content.

The inventors have discovered that providing multiple sources of protein and lipids, including corn gluten, leads to improved honeybee health and longevity. The combination of proteins, lipids, and carbohydrates benefits the colony by providing the food source necessary to develop colony strength and as well as to maintain a high and healthy brood production. The high quality and excellent palatability of the compositions of the invention are especially suitable for fall, winter or early spring feeding. In addition, the compositions of the invention offer commercial operations, queen breeders and hobbyist beekeepers an excellent tool to boost colony strength, population, and brood production for a more effective pollination season and potentially higher honey yields.

In one embodiment, the artificial diet formulation includes about 20-80% protein derived from at least two sources including corn gluten, about 1-7% lipid derived from at least two sources including corn gluten, and about 10-90% carbohydrate. The inventors have found that particles in the formulation preferably are less than 35 microns in diameter. The relatively small diameter of the particles (compared to other artificial bee diets) is thought by the inventors to be important in the improvement of the absorption and the conversion to usable food reserves during the digestive process.

In another embodiment of the invention, the diet further includes protein derived from one or more of soy concentrate, barley flour, yeast, or corn distillers dried grains. Similarly, the lipids of the diet may be derived from one or more of soy concentrate, barley flour, yeast, or corn distillers dried grains.

In some embodiments, the diet preferably is a liquid diet that includes high-fructose corn syrup as the carbohydrate source. The diet also may be formulated in dry form and mixed with a sugar syrup prior to use to form a liquid. Alternatively, a patty or a dry formulation or may be formed by using less syrup or a solid carbohydrate source and bringing the product to a dough like or powdery consistency that is placed in the colony for the bees to eat.

Preferably, formulations of the invention further include about 3-6% ash, about 2-5% citric acid, and about 1-2% antifungal agent in order to have suitable acidity and stability. Also preferably, formulations of the diet is substantially free of egg-derived protein. The inventors have found that previous bee diet compositions containing egg can be difficult for the bees to digest, perhaps due to the high lipid content of eggs. Moreover, because of the high fat levels, the inventors have found that egg-containing product is more prone to deteriorate and oxidize over time and consequently lose its nutritional value.

In other embodiments of the invention, the diet is formulated to include about 40-60% protein derived from at least two sources including corn gluten, about 1-5% lipid derived from at least two sources including corn gluten, and about 40-60% total carbohydrates, of which typically 0.4% are digestible carbohydrates, about 3-6% ash, and about 2-5% citric acid, with at least a majority of the particles in the formulation being 35 microns in diameter or less.

In still other embodiments of the invention, the diet is formulated to include about 40-60% protein derived from at least three sources including corn gluten, soy concentrate, and barley flour, about 2-4% lipid derived from at least two sources including corn gluten, about 40-60% carbohydrate, of which typically 0.4% are digestible carbohydrates, about 3-6% ash, and about 2-5% citric acid, with a majority of the particles in the formulation being less than 35 microns in diameter.

The invention also comprises methods of making and using the artificial diets and diet formulations. The diets of the invention provide a complex mixture which includes proteins, lipids, carbohydrates, minerals, and other nutrients to provide all the dietary requirements for bees to rear multiple generations of young bees when there is an absence of natural pollen and nectar. The formulations are pH balanced to mimic the pH of natural pollen and promote a healthy gut environment in the bees. Optionally, anti-microbial agents may be included to prevent pre-mature deterioration of the diet.

The combination of ingredients in the diet formulations assure that a smooth, evenly mixed, substantially homogeneous, non-clumping mixture is obtained when the dry formulation is mixed with a liquid and that the formulation is palatable to bees and provides bees nutrients to raise multiple generations of young bees.

Additional features and advantages of the invention will be forthcoming from the following detailed description of certain specific embodiments when read in conjunction with the accompanying drawings.

### BRIEF DESCRIPTION OF THE DRAWINGS

FIG. 1 illustrates that there was no significant difference in the amount of consumption between Natural Pollen, BeePro, Feed Bee, and MegaBee (a composition of the invention). FeedBee demonstrated significantly less consumption than the other products. The x axis illustrates mean grams of diet consumed over time.

FIG. 2 depicts that, while there was no significant difference in the rate of consumption between BeePro, Pollen, Feed Bee, and MegaBee (a composition of the invention), MegaBee produced significantly more brood.

FIG. 3 illustrates that colonies fed MegaBee (a composition of the invention) demonstrated higher adult bee populations which would be a function of more young bees coming into the population and longer lived adult bees.

FIG. 4 shows the average amounts of honey bee diets consumed by colonies during three week intervals (A) and for the 12 week study period in Trial-1 and at 2-week intervals and a 6-week study period for Trial-2. Column averages labeled with the same letters are not significantly different at the 0.05 level as determined by a Fisher's LSD.

FIG. 5 shows the average change in brood area and adult population size in European honey bee colonies fed different diets during a 12 week interval for Trial-1 and a 6-week interval for Trial-2. The diets were: FeedBee (FB), BeePro (BP), MegaBee liquid (MB(1), MegaBee patty (MB(p)), pollen cake (Pol), or high fructose corn syrup as a control (C). Columns averages labeled with the same letters are not significantly different at the 0.05 level as determined by a Fisher's LSD. Separate analysis of variance were conducted for brood counts done at mid-trial and these means are labeled with capital letters to denote differences, and at the end of the trial with small case letters

FIG. 6 depicts in tabular form the difference in brood size caused by different diets, where Mean Sq. In.=Mean square inches per colony, and N=the number of colonies treated.

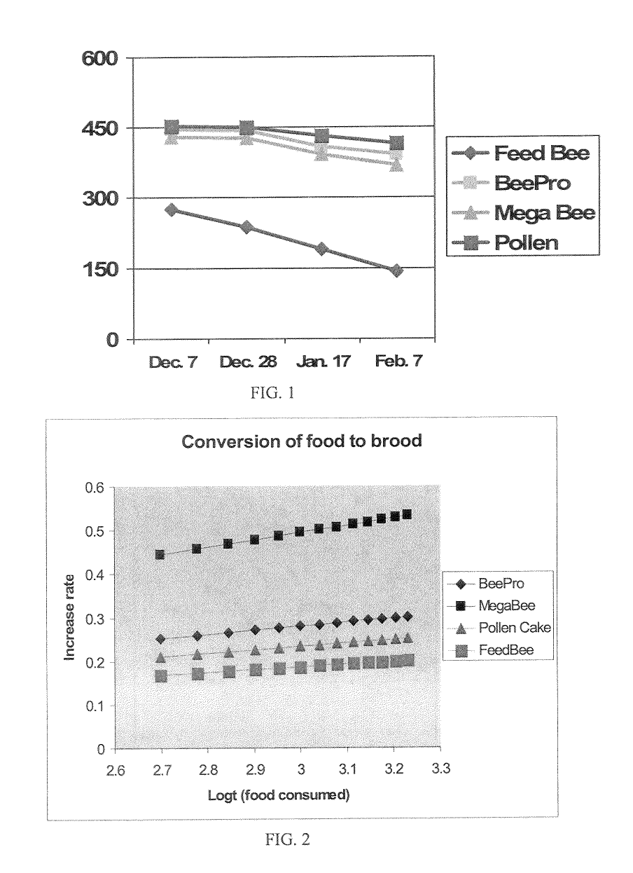

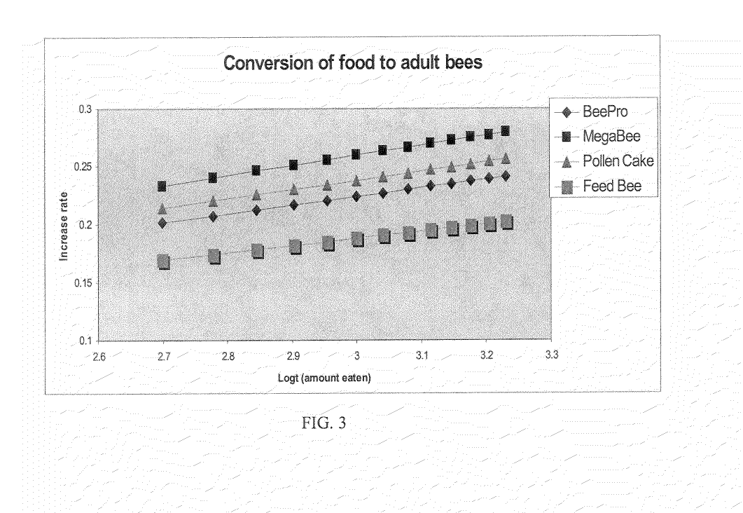

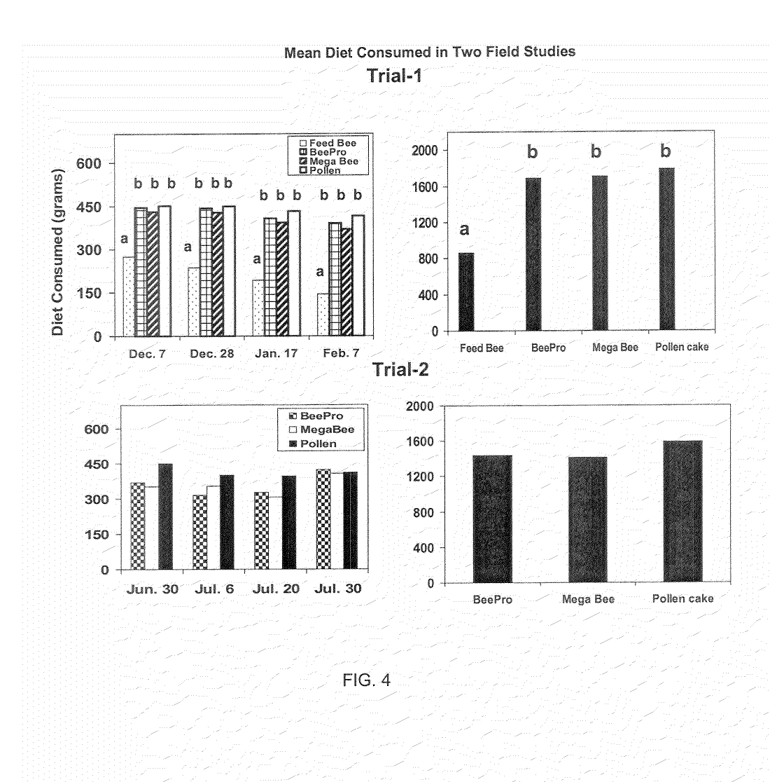

### DESCRIPTION OF THE PREFERRED EMBODIMENTS

Unless defined otherwise, all technical and scientific terms used herein have the meaning commonly understood by a person skilled in the art to which this invention belongs. The following reference provides one of skill with a general definition of many of the terms used in this invention: The Hive and The Honeybee, Ed. Joe M. Graham, Dadant & Sons, Inc., Hamilton, Ill. 1975, 1992 editions.

The term “honey bee” refers to members of the Order Hymeoptera, Family Apidae and includes by way of example, the species Apis mellifera, and Apis cerana. The term “colony” refers to a community of bees with a single queen, thousands of workers, and brood. During part of the year there are also several hundred drones. The term “comb” refers to sections of hexagonal bees wax cells built by honey bees and used to rear their brood and store honey and pollen. The term “hive” refers to the cavity/domicile occupied by a honey bee colony. The modern box hive includes a bottom board, cover, and one or more boxes, stacked one above the other. Inside, each box contains a series of movable frames of comb or foundation held in a vertical position a bee space apart. The young of honeybees are collectively called “brood.” In modern hives, the nursery area is in the “brood chamber,” which is generally the bottom box.

The following Table provides the broad, preferred, and more preferred amounts of the nutrient components, pH, and particle size of the diets of the invention. The ranges of the nutrient components in the dry diet formulations are determined from the Table by recalculating percentages after removal of the water component.

TABLE 1

| Broad | Preferred | More Preferred |
|---|---|---|
| 20-80% protein | 40-60% protein | 40-60% protein |
| 1-7% lipid | 1-5% lipid | 2-4% lipid |
| 10-90% carbohydrate | 40-60% carbohydrate | 40-60% carbohydrate |
| Particles less than | Particles less than | Particles less than 35 μm |
| 35 μm | 35 μm | |

Note:
Particle sizes refer to a mean size in diameter or less. The preferred pH for these formulations is about 4.5. Carbohydrate is total carbohydrate, of which typically 0.4% are digestible carbohydrates.

The following ingredients, in combination, provide the nutrients required for the diet formulations of the invention.

Protein and Lipid Sources. Protein and lipid sources are preferably corn gluten sources in combination with soy concentrate, barley flour, yeast, and/or corn distillers dry grains. Corn gluten, such as that sold as a granular 60% protein product number 138930 under the Prairie Gold® trademark, is noted for its high energy and methionine content and as a source of xanthophylls.

Soy concentrate contributes one of the most complete profiles of essential amino acids of any plant material (slightly lacking in the sulfur containing amino acids cysteine/cystine and methionine), and it is also a source of lipoproteins, which help deliver sterols and polyunsaturated fatty acids. It is a naturally lipid-rich food material. The soy used in these diets also contains a range of vitamins and minerals that are required by bees, and may contain the natural antioxidants known as isoflavones. A preferred soy concentrate source is sold under the brand name SOYCOMIL®, because it has low levels of anti-nutritional factors.

If needed, the soy source is treated. In the soy protein isolation process the soy source is treated and purified to inactivate any anti-nutrients and anti-feedants found in the raw state (including urease, protease inhibitors, amylase inhibitors, phytic acid, other sequestrants that act like phytic acid, lectins and lipooxygenases) that may be present in the source proteins. These substances are destroyed by heating or they can be destroyed by other processes such as enzymatic treatments, chemical purification, or fermentation.

Barley flour is produced from the milling of whole grain barley. Barley flour provides protein, fat, ash and moisture and is readily available from sources such as Labudde Group in Grafton, Wis. Distillers dry grains (such as that sold under the trademark SOLULAC®) and yeast also provide protein, lipids, and various vitamins and minerals to the diet.

The lipids in the diet include several classes that include polar and neutral lipids. All the lipids contribute a nutritional function to the diet, including essential factors such as sterols, polyunsaturated fatty acids, and lipoidal vitamins (vitamin A and vitamin E derivatives). The lipids also serve metabolically as a source of energy and as carbon sources for growth. The lipids also function as agents of sensory attraction in terms of taste and texture. The lipids serve further as emulsifiers (especially the polar lipids, including lecithin and lecithin-like substances, free fatty acids, mono- and di-glycerides) and contribute to the smoothing of the diet. By providing multiple sources of protein and lipids, the inventors have found that the diet formulations of the invention provide for improved colony strength, longevity, brood production and overall longevity.

It is preferred that corn and other protein source(s) are mixed together. This may be carried out with or without the presence of the other diet ingredients.

Acidifier Source. The formula is pH balanced to mimic the pH of natural pollen and promote a healthy gut environment. Preferably, the formulation includes one or more organic acids or phosphoric acid as acidifier sources to achieve the pH stability of the diet. These sources are included in the diet formulations to maintain the pH of the formulation in the range of 3.5 to 7. As noted in the Table above, the more preferred pH is about 4.5. The preferred acidifier compounds are the organic acids such as citric acid, acetic acid, lactic acid, malic acid, fumaric acid, or succinic acid and combinations of organic acids such as malic acid, fumaric acid, and pyruvic acid. The inorganic acid, phosphoric acid, may also be used. Several of these acids also confer antimicrobial potential (e.g., acetic and lactic acids). Some also serve as chelating agents, which may be important to delivery of minerals and antioxidant properties (e.g., citric acid and succinic acid). Ascorbic acid also may be included in the diet formulations as a primary nutrient serving as a source of vitamin C for the bees.

We have found that citric acid works very well in the formulations. In addition to maintaining the pH, citric acid is known to serve as a sequestrant or chelating agent, which may help deliver minerals and in chelating metallic components (such as iron and zinc).

Sugar Source. The sugar source in the bee diet formulations serves as a feeding stimulant, a source of carbon for building blocks for growth, a source of energy, a viscosity increasing agent (texturizer), and a humectant (water retaining agent), which lower water activity that reduces microbial growth and inhibits chemical reactions that help deteriorate diets. Also, at the high concentrations specified herein, the sugars contribute substantially to the viscosity of the diet, therefore they influence its texture and resistance to separation.

Examples of sugar sources include sucrose, e.g., crystalline or granulated; other crystalline or granulated sugars, e.g., fructose, glucose (also denoted as dextrose) or maltose; high fructose corn syrup, e.g., HFCS55, or other sugar syrup. They can be used in the solid form or as a syrup.

Examples of liquids include water and diluted sugar syrups. The liquid functions to make the diet pourable and deliverable.

Anti-fungal and/or anti-microbial agents. Anti-fungal and/or anti-microbial agents are optionally added to the diet formulations to prevent premature deterioration of the formulations. These are generally required under conditions where the diet will be used for more than 24-48 hours without being used up or discarded. They are desirable even for shorter periods because at typical hive temperatures, microbes can proliferate rapidly and spoil the diet and serve as potential pathogens to the bees. The primary antimicrobial agents are sorbic acid and its salts, propionic acid and its salts, the series of parabens (methyl, ethyl, propyl, and butyl form), benzoic acid and its salts. We have found that potassium sorbate and sodium propionate work well in the formulation. Potassium sorbate, a fatty acid, has well-demonstrated anti-fungal and anti-microbial properties. Sodium propionate is an effective anti-microbial agent and approved preservative. Other anti-fungal and/or antimicrobial agents are known in the art, including for example calcium propionate.

The diet formulations are essentially free of meat products and insect parts, and preferably free of pollen, bee bread, or propolis.

Particle Size. In all cases, the particles in the final diet formulation are milled to include a mean size of particles that are about 35 microns in diameter or less.

The liquid diet formulations provide an evenly mixed, water-dispersible, substantially homogeneous, substantially non-clumping, pourable, flowable liquid wherein nutrients are dissolved therein, suspended therein, and/or emulsified therein. For example, ascorbic acid is dissolved in the liquid, soy particles are suspended in the viscous aqueous matrix, and there is an emulsion with the lipid/lipoprotein micelles emulsified by the apoproteins and the lecithin emulsifying the free neutral lipids. For simplicity, the liquid diet formulation may be referred to as a smooth solution or suspension. This unique composition of nutrients prepared as described herein provides a liquid bee diet “smoothy” that is palatable to the bees, easily digestible, and fully nutritious. The formulations of the invention provide a complex mixture of nutrients in amounts and proportions effective to support growth and development of honey bees. The diet formulations of the invention are thought to be among the first artificial bee diets that sustain brood rearing and can be used for the continuous rearing of bees. Thus, the invention fills an important long felt need of beekeepers and the bee industry.

In another embodiment, the invention is directed to stable, dry diet formulations suitable for shipping, storage, and/or feeding. The dry diet formulations contain the dry ingredients in a form and proportion such that when the dry formulation is mixed together with water or liquid formulation, as discussed in detail below, it provides the liquid diet formulation having the properties described above. Alternatively, the dry formulations may be fed directly to bees without liquid being added. The dry diet formulations may comprise several formulations. Without being limiting, these include: (A) a composition which includes all the critical ingredients listed above, namely, lipid and protein sources, ascorbic acid source, acidifier source, sugar source, and may include the optional ingredients, namely, anti-fungal and/or anti-microbial agent. The composition does not include water. The dry formulation may be mixed with the water to form the liquid bee diet of the invention; and (B) A composition which includes all the critical dry ingredients of (A) except for the sugar source and may include the optional ingredients. The dry formulation is mixed with the sugar source and water (or a sugar syrup, or fructose corn syrup alone) to form the liquid bee diet of the invention.

Methods of Making The following processes may be included alone or in combination, as needed to provide the liquid diet composition of the invention: blending, size reduction, and minimal heating. Preferably, the dry ingredients are mixed and blended in a ribbon blender to achieve complete mixing before grinding and size reduction of the particles. The mixing is carried out sufficient to render the components into a well-dispersed form that is available in a substantially homogeneous manner.

Preferably, mill temperatures do not go above 85 F. The inventors have found that if the diet gets above 150 F for more than a few minutes, it changes the texture of the final product and there is more agglutination in the final patty. Mixing and heating parameters for a particular set of circumstances can be readily determined by routine experimentation as shown in the methods and formulations described in detail below. The formulations may comprise the liquid diet formulation or dry diet formulations with or without the sugar source. The latter formulations are mixed with sugar syrup or water and a sugar source to provide the final liquid diet formulation.

In the methods of the invention, the diet or diet formulations are placed in an area where bees are located or within feeding vicinity of bees, such as in or adjacent to a bee hive or bee cage, or also inside the hive as a patty or as a liquid. The diet or diet formulations are provided in an amount effective for providing nutrients effective to support growth and development of honey bees. Exemplary uses of the diets and diet formulations are for feeding bees and bee colonies, sustaining brood rearing, maintaining hive vigor, providing bees with nutrients to rear multiple generations of young bees, providing nutrition sources for bees that are moved during commercial crop pollination or other migratory beekeeping uses, providing a diet that supports queen rearing, and providing all the dietary requirements for bees to rear multiple generations of young bees when there is an absence of natural pollen and nectar. Other applications include: 1. Building honey bee colony populations prior to and during pollination; 2. Building honey bee colony populations prior to the honey flow; 3. Feeding to bees in queen rearing operations, the swarm boxes, cell builders, mating nucs and queen banks; 4. Use as a supplemental diet for greenhouse bumble bees; 5. Use as a carrier for therapeutic treatments in the bee colonies such as controls for parasitic mites, pathogenic bacteria, protozoans and fungi.

The following provides descriptions of specific liquid formulations that illustrate the various formulations of the invention.

MegaBee Liquid Diet 34

10 g of ground corn gluten 60%

5 g barley flour

5 g Soycomil K (ADM soy concentrate)

5 g ground Solulac grains

1 g citric acid

0.2 g potassium sorbate

0.2 g sodium propionate

Mix solids and grind in ZM 200 grinder.

Take 10 g of the above+100 ml 1:1 water:sugar syrup.

MegaBee Liquid Diet 31A

40 g ground corn gluten 60%

20 g barley flour

20 g Soycomil K (ADM soy concentrate)

20 g ground Solulac grains

4 g citric acid

1 g guar gum (Sigma)

0.8 g potassium sorbate

0.8 g sodium propionate

Mix solids and grind in ZM 200 grinder.

Take 10 g of the above+100 ml 1:1 water:sugar syrup.

MegaBee Liquid Diet 6

20 g ground corn gluten 60%

5 g barley flour

5 g brewer's yeast (lab)

0.7 g citric acid

0.7 g ascorbic acid

0.5 g locust bean gum

0.5 g xantham gum

0.2 g potassium sorbate

0.2 g sodium propionate

Mix solids and grind in Vitamix mixer for 30 sec.

Add 10 g of the above+100 ml 1:1 sugar syrup.

Another use of the diets of the invention is to prepare patties for presenting the diets to the bees. The patty is a mixture of sugar syrup and the diet formulation to form soft pliable dough-like consistency that is pressed into a thin patty and placed into honey bee colonies to support the protein and nutritional need of the colony. While the dry diet formulation can be mixed with fructose corn syrup or sugar syrup solution to form a liquid diet application, the same dry formulation can be mixed with lesser amounts of fructose corn syrup or sugar syrup to form a patty or a patty can be prepared by adding less fructose corn syrup or sugar syrup to a liquid formulation.

In order to make a patty, mix 1 part powder ingredients by weight plus 1.5 to 1.8 parts of syrup (fructose or sucrose) by weight. Let it soak overnight and make into a patty. In a preferred embodiment, the dry ingredients are ground and mixed together, and then the liquid component is added as the mixture is being stirred either in a commercial mixer or by any means necessary to get a substantially homogeneous mixture and a smooth dough-like consistency. The resultant mixture should preferably be allowed to rest overnight to fully absorb the moisture. Then the mixture is used to form smooth, firm but moist patties.

The following provides descriptions of specific patty formulations that illustrate the various formulations of the invention.

MegaBee Patty Formula 10

10 g ground corn gluten 60%

5 g soyflour (Mannlake)

5 g barley flour

5 g brewer's yeast (fresh)

5 g ground Solulac grains

0.7 g citric acid

0.7 g ascorbic acid

0.5 g Kelcoloid d

0.2 g potassium sorbate

0.2 g sodium propionate

Mix solids and grind in Vitamix mixer for 30 sec.

Mix 20 g of the above+20 g of plain sugar syrup.

MegaBee Patty Formula 13

10 g ground corn gluten 60%

10 g Soycomil K (ADM soy concentrate)

5 g barley flour

5 g ground Solulac grains

1 g ascorbic acid

0.2 g potassium sorbate

0.2 g sodium propionate

Mix solids and grind in Vitamix mixer for 30 sec.

Mix 20 g of the above+20 g of plain sugar syrup.

MegaBee Patty Formula 15-1

10 g ground corn gluten 60%

5 g barley flour

5 g Soycomil K (ADM soy concentrate)

5 g ground Solulac grains

5 g Brewer's Yeast

1 g citric acid

0.2 g potassium sorbate

0.2 g sodium propionate

Mixed solids and grind in Vitamix for 30 sec.

Mix 20 g of the above with 20 g of plain sugar syrup.

### EXAMPLES

The following examples are intended only to further illustrate the invention and are not intended to limit the scope of the invention which is defined by the claims.

### Example 1

The following is an example of an In vitro feeding experiment and field trial wherein the liquid formula and patty formula of the invention are compared with known bee diets for longevity, food consumption, colony population and brood production.

Preparation of Treatments

1. Liquid Protein Diet Ingredients and Mixing Protocol. Using MegaBee patty formulation 15-1 in a liquid consistency as disclosed above, or following the directions given for Feed Bee or Bee Pro, dry ingredients were ground together and the powder was added to fructose corn syrup and mixed by hand with a spatula until a smooth solution was attained (1 minute of stirring). The mixture was refrigerated until poured into vials attached to the cage feeders containing the bees for the longevity trial. For the patty of the invention, MegaBee patty formulation 15-1 was used (as described above).

2. Pollen Cake Ingredients and Mixing Protocol. Pollen patties were made by mixing pollen collected by honey bees to granulated sucrose, Drivert sugars (a commercially available mixture of equal amounts of dry fructose and sucrose) and tap water.

Pollen and water were mixed together in a Hobart bakery mixer using the dough hook until the pollen pellets were suspended (7 to 10 minutes). The entire amount of sucrose was then added to the pollen slurry and mixed until smooth (3-5 minutes depending upon the consistency of the pollen). Drivert sugar then was added and mixed until the mixture had a dough-like consistency and pulls away from the sides of the bowl (3 minutes). The mixture was rolled between two sheets of wax paper into patties with a thickness of 0.25 inch. Pollen cake patties were stored in a −20 degree C. freezer. The patties were thawed to room temperature prior to placing them into the cages with the bees.

Sugar Syrup Solution Ingredients and Mixing Protocol. A mixture of equal weights of dry sucrose and hot tap water were mixed until the sugar was completely dissolved. The finished solution was stored in containers at room temperature. Sugar syrup was placed into the cages with the bees within 24 hrs after mixing. The sugar syrup was used as the control.

Measuring Longevity. To determine if the diets affects longevity of adult worker bees, we followed the procedural methods for a caged longevity study described by Schmidt et al. (1987). Within 24 hrs of emergence (hereinafter referred to as emerging brood) five frames of sealed brood were placed in a screened emergence box. All adult worker bees were brushed from the frames prior to placing the frames in the box so that all adult bees on the frames would be newly emerged. The emergence box was placed in an environmentally controlled room (incubator room) at 32-34 degrees Centigrade and 70% relative humidity. To test the longevity of bees fed the liquid and patty protein diet, newly emerged worker bees were removed from the emergence box and weighed. 10 g of bees (approximately 100 workers) were placed in a wooden box (20.0 cm width and 15.5 cm height) equipped with a glass tube containing 20 ml of liquid protein diet that was dispensed into a trough (1 cm wide 3.3 cm long) for feeding. Each cage was provided with a 3.5 by 7 cm strip of honey bee foundation wax on which the bees were intended to cluster. Water was provided ad libidum through a 30 ml plastic screw cap bottle with feeding holes.

To compare the longevity of bees fed pollen cake or a 50% sucrose and water solution (controls) with those fed the protein diets, six grams (approximately 60 worker bees) of newly emerged bees were placed in feeding cages (9×6×15 cm) made of Plexiglas and screen. Each cage was provided with a 3.5 by 7 cm strip of honey bee foundation wax on which the bees were intended to cluster. Bees were supplied with 40g of the protein diet or pollen in a plastic dispenser. The cages also contained 50% sugar solution and water containers. The bees were fed ad libidum. Water and 50% sugar syrup was provided as needed to the control cages. All cages were placed in an incubator room at temperatures between 32-35 degree C., constant darkness, and 70% relative humidity.

Five cages were used for each treatment. Mortality in each cage was recorded three times weekly by removing and then counting the number of dead bees in the cages. Weekly mean survivorship for each treatment was compared with the controls using a one-way analysis of variance. Components placed in each cage for the different treatments in longevity test.

Analysis of Hemolymph Proteins from each Treatment. Total hemolymph protein from adult bees fed the various treatments was analyzed using the methods outlined in Bradford, M. M. 1976. A rapid and sensitive method for the quantification of microgram quantities of protein utilizing the principle of protein-dye binding. Ann. Biochem. 72: 248-254. Hemolymph was extracted from the dorsal vessel of five bees from each treatment using a pointed micropipette to puncture the body wall near or over the heart. The hemolymph was collected with 10 ul capillary tubes and pooled for each treatment in microcentrifuge tubes. The sample was put in ice to prevent denaturing of the proteins. 5 ul of hemolymph was taken from each pooled sample and added to 200 ul of saline buffer in a 1.5 ml microcentrifuge tube. The mixture was centrifuged at room temperature for 1 minute at 15,000 g to remove hemocytes. The supernatant was stored at −20 degrees C. until analysis.

The supernatant was analyzed for total protein content using a Coomassie Plus(TM) Protein Assay Kit (#23236) (Pierce Inc., Rockford, Ill.). The kit contains a concentrated form of Coomassie blue G-250 that was diluted 1:4 with distilled water before use. Bovine serum albumin was used as a protein standard and has a typical color response curve for spectrophotometric analysis between 25-2000 ug per ml. 100 ul of the diluted hemolymph sample (supernatant) was placed into 3.0 ml of the diluted Coomassie blue G-250 in glass test tubes. For comparison purposes, we created a blank composed of 100 ul of saline buffer added to 3.0 ml Coomassie blue G-250. The samples were analyzed for total protein content using a Spectronic 20 spectrophotometer. Absorbance values generated from the spectrophotometer were converted to ug/ml by comparing them with the protein standard curve (Bovine serum albumin).

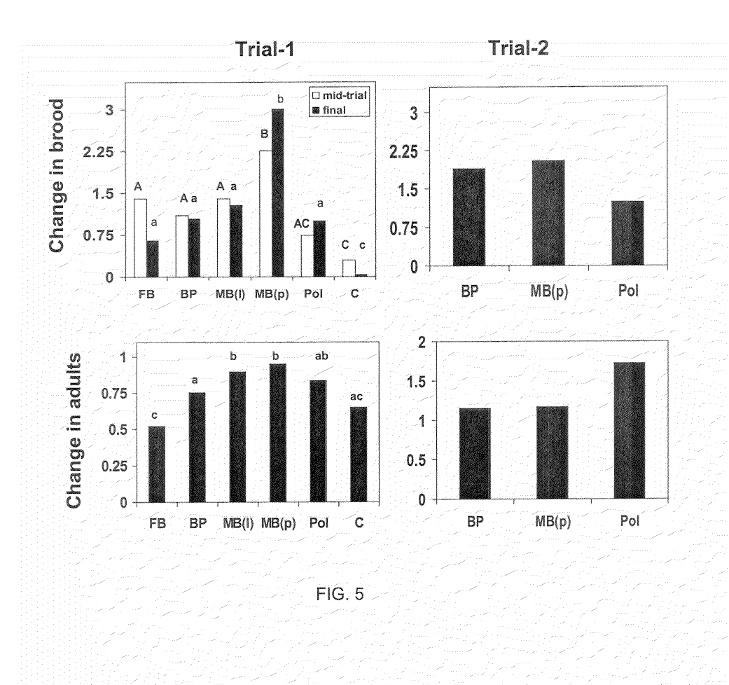

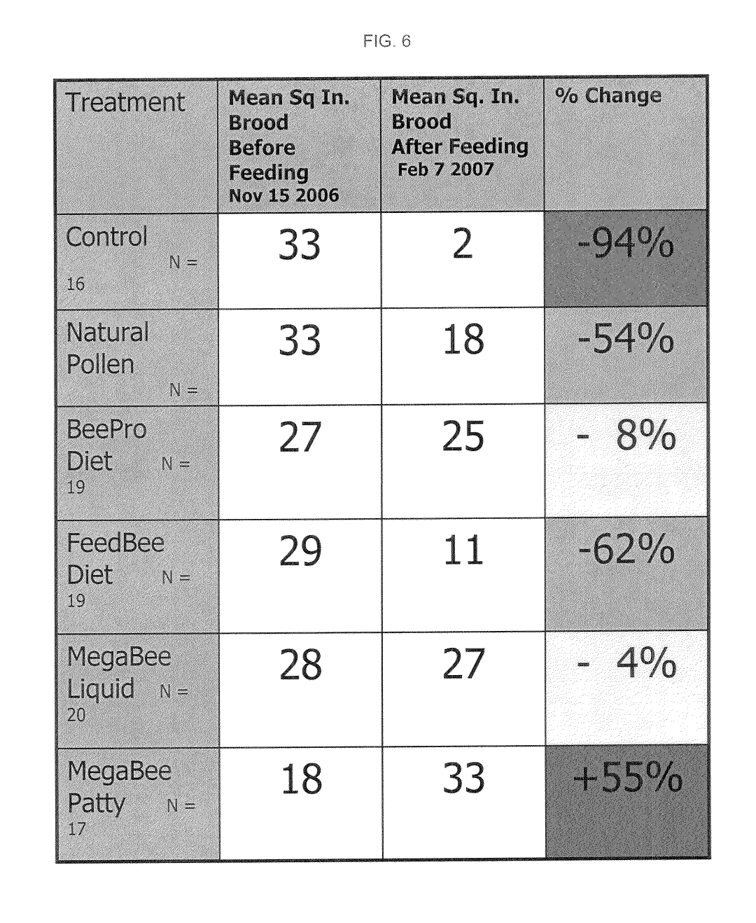

The results of the longevity, change in adult population, brood production are shown in FIGS. 4, 5 and 6. The results show that the diet of the invention works better in insuring worker longevity. The hemolymph protein levels (after 15 days) are higher in the diet of the invention fed to the bees compared with the hemolymph protein levels of the bees fed pollen or the other diets. Data collected at mid term in the field trial showed a substantial increase in brood production and adult population (FIG. 5), and the average longevity of bees fed the diets of the invention was greater than those fed pollen or another diet (t-test: t=6.17, p=0.0035). These results show that compositions of the invention are effective to support growth and development of honey bees, sustain brood rearing, and support continuous rearing of bees, and maintain hive vigor.

Alternative Formulations.

There are many ways compositions of the invention can be mixed with different media such as: fructose corn syrup, sugar-water solution 1:1 ratio, sugar-water solution 2:1 ratio, commercial sucrose-fructose blend to be made into a patty or a liquid as directed by mixing instructions.

Also, adding different kinds of sugars as dry components such as dry sucrose, powdered sugar, drivert sugar (which is a mix of dry fructose and sucrose) or confectionary sugar to a composition recipe will help weak colonies to increase consumption and therefore, enhance colony strength and boost brood production. The compositions of the invention (hereinafter MegaBee in the sample recipes below) could be made into a fondant by adding fructose corn syrup or other liquid media as described.

Sucrose variations

1. MegaBee Fondant with Sucrose:
10% MegaBee+90% sucrose
20% MegaBee+80% sucrose
30% MegaBee+70% sucrose
40% MegaBee+60% sucrose
50%-90% MegaBee+50%-10% sucrose

Blend the dry ingredients together and then add the liquid media (described above) to make a thin soft paste. Let sit overnight in an air tight container and make a patty the next day.

Fondant variations

2. MegaBee Fondant with Powdered sugar:
10% MegaBee+90% powdered sugar
20% MegaBee+80% powdered sugar
30% MegaBee+70% powdered sugar
40% MegaBee+60% powdered sugar
50%-90% MegaBee+50%-10% powdered sugar

Blend the dry ingredients together and then add the liquid media (described above) to make a thin soft paste. Let sit overnight in an air tight container and make a patty the next day.

3. MegaBee Fondant with Drivert sugar:
10% MegaBee+90% drivert sugar
20% MegaBee+80% drivert sugar
30% MegaBee+70% drivert sugar
40% MegaBee+60% drivert sugar
50%-90% MegaBee+50%-10% drivert sugar

Blend the dry ingredients together and then add the liquid media (described above) to make a thin soft paste. Let sit overnight in an air tight container and make a patty the next day.

4. MegaBee Fondant with equal parts of Powdered sugar and Drivert sugar:
10% MegaBee+90% drivert—powdered sugar mix sugar
20% MegaBee+80% drivert—powdered sugar mix sugar
30% MegaBee+70% drivert—powdered sugar mix sugar
40% MegaBee+60% drivert—powdered sugar mix sugar
50% MegaBee+50% drivert—powdered sugar mix sugar

Blend equal amounts of powdered sugar and drivert sugar and use that mix to make the fondant with MegaBee. Blend the dry ingredients together and then add the liquid media (described above) to make a thin soft paste. Let sit overnight in an air tight container and make a patty the next day.

Megabee and Water-Binding Natural Fibers

Natural fiber commercial products described as water-binding agents can be added to MegaBee to help keep the patty diet moist over time. These products can be used alone or in combination with sugars and also made into fondant variations as well. One such product is called Hydrobind Carrot Fiber.

MegaBee and Hydrobind variations

The product was mixed at different concentrations with sucrose and without sucrose.

1. MegaBee and Hydrobind:
MegaBee+1% Hydrobind
MegaBee+2% Hydrobind
MegaBee+3% Hydrobind

Blend the dry ingredients together and then add the liquid media (described above) to make a thin soft paste. Let sit overnight in an air tight container and make a patty the next day.

2. MegaBee, Hydrobind and sucrose:
MegaBee+1% Hydrobind+50% sucrose
MegaBee+1% Hydrobind+40% sucrose
MegaBee+1% Hydrobind+30% sucrose
MegaBee+1% Hydrobind+20% sucrose
MegaBee+1% Hydrobind+10% sucrose
MegaBee+2% Hydrobind+50% sucrose
MegaBee+2% Hydrobind+40% sucrose
MegaBee+2% Hydrobind+30% sucrose
MegaBee+2% Hydrobind+20% sucrose
MegaBee+2% Hydrobind+10% sucrose
MegaBee+3% Hydrobind+50% sucrose
MegaBee+3% Hydrobind+40% sucrose
MegaBee+3% Hydrobind+30% sucrose
MegaBee+3% Hydrobind+20% sucrose
MegaBee+3% Hydrobind+10% sucrose

Blend the dry ingredients together and then add the liquid media (described above) to make a thin soft paste. Let sit overnight in an air tight container and make a patty the next day.

Another formulation of the compositions of the invention relate to candy board embodiments. Beekeepers typically use this method to feed sugar to their colonies during the winter. To make approximately a 10 lb batch, the following is needed:
7 lbs Sugar
1.5 lbs High-Fructose Corn Syrup (HFCS)
1 lb Water
1 lb MegaBee (Patty Formula 15-1)

Bring sugar, water, and HFCS to a slow boil while stirring until “Hard Ball” candy consistency is reached (typically this occurs ˜250 to 260 degrees F.). Remove from heat and stir in MegaBee with a whisk. Pour mixture into a mold and allow to cool. The mold may be lined with wax paper to make extraction very easy.

The candy board is a reliable way to emergency feed bees carbohydrates in the winter when it can be hard to put sugar syrup in the colony or when the bees would rather cluster for warmth than feed on frigid syrup. The Candy Boards are generally produced to fit on the top of the colony in the bee space between the top bars of the colony and the inner-cover or outer-cover, therefore they would have to be no more than ⅜ inch in most instances. Because the Candy Board is sitting above the brood nest the heat and moisture of the colony will soften the candy and make it easy for the bees to begin consuming the candy and protein at the same time. The bees will consume the candy as needed and the inclusion of MegaBee in the formulation will sustain their protein needs while the sugar will sustain their carbohydrate needs. Moreover, by adding MegaBee to the candy board, protein, nutrients and vitamins are introduced so the bees will be able to sustain brood rearing while being fed under winter conditions.

Early data indicates that bees fed protein along with carbohydrates live longer than bees not given the protein. This may result in extending the life of the adult bees.

The range of MegaBee that can be put into the hot candy ranges from about 5% to 60%, with the optimum range being between approximately 10% and 40%.

Various modifications are possible within the meaning and range of equivalence of the appended claims.

We claim:

1. An artificial diet formulation suitable for rearing bees, comprising:
about 20-80% protein derived from at least two sources including corn gluten, about 1-7% lipid derived from at least two sources including corn gluten, and about 10-90% carbohydrate.

2. The diet of claim 1, wherein particles in the formulation are milled to a mean size of 35 microns in diameter or less.

3. The diet of claim 1, wherein said protein derived from at least two sources further includes one or more of soy concentrate, barley flour, yeast, or corn distillers dried grains.

4. The diet of claim 1, wherein said lipids derived from at least two sources further include one or more of soy concentrate, barley flour, yeast, or corn distillers dried grains.

5. The diet of claim 1, wherein said carbohydrate comprises high-fructose corn syrup.

6. The diet of claim 1, further comprising about 3-6% ash, about 2-5% citric acid, and about 1-2% antifungal agent.

7. The diet of claim 2, further comprising about 3-6% ash, about 2-5% citric acid, and about 1-2% antifungal agent.

8. The diet of claim 1, wherein said protein, lipid, and carbohydrate are formed into a hard candy.

9. The diet of claim 1, wherein said diet is substantially free of egg-derived protein.

10. A diet formulation suitable for rearing bees, comprising:
about 40-60% protein derived from at least two sources including corn gluten, about 1-5% lipid derived from at least two sources including corn gluten, and about 40-60% carbohydrate, about 3-6% ash, and about 2-5% citric acid.

11. The diet of claim 10, wherein particles in the formulation are a mean size of 35 microns in diameter or less.

12. The diet of claim 10, wherein said protein derived from at least two sources further includes one or more of soy concentrate, barley flour, yeast, or corn distillers dried grains.

13. The diet of claim 10, wherein said lipids derived from at least two sources further includes one or more of soy concentrate, barley flour, yeast, or corn distillers dried grains.

14. The diet of claim 10, wherein said carbohydrate comprises high-fructose corn syrup.

15. The diet of claim 10, further comprising about 1-2% antifungal agent.

16. The diet of claim 11, further comprising about 1-2% antifungal agent.

17. The diet of claim 10, wherein said protein, lipid, and carbohydrate are formed into a hard candy.

18. The diet of claim 10, wherein said diet is substantially free of egg-derived protein.

19. A diet formulation suitable for rearing bees, comprising:
about 40-60% protein derived from at least three sources including corn gluten, soy concentrate, and barley flour;
about 2-4% lipid derived from at least two sources including corn gluten,
about 40-60% carbohydrate,
about 3-6% ash; and
about 2-5% citric acid, wherein particles in the formulation are a mean size of 35 microns in diameter or less.

20. The diet of claim 19, further including a predetermined amount of yeast.
